(19) United States
(12) Patent Application Publication
(10) Pub. No.: US 2011/0038774 A1
(43) Pub. Date: Feb. 17, 2011

(54) Method for Sequestering Carbon Dioxide

(76) Inventor: Shaojun Zhong, Burnaby (CA)

Correspondence Address: Shaojun Zhong, 4944 Watling Street, Burnaby, British Columbia, V5J 1W7, omitted

(21) Appl. No.: 12/830,440

(22) Filed: Jul. 6, 2010

Related U.S. Application Data
(60) Provisional application No. 61/234,195, filed on Aug. 14, 2009.
(60) Provisional application No. 61/264,691, filed on Nov. 26, 2009.
(60) Provisional application No. 61/289,876, filed on Dec. 23, 2009.

(51) Int. Cl. B01D 53/62; C01C 1/02

(52) U.S. Cl. 423/234; 423/357

(57) ABSTRACT

A method for sequestering carbon dioxide (CO₂) that includes generating ammonia from an ammonium salt to make a basic ammoniated aqueous solution and using the solution to remove at least a portion of CO₂ from a CO₂-bearing gas and precipitate the removed CO₂ as bicarbonate. The aqueous solution is recycled. Various valuable byproducts, including sodium bicarbonate, sodium carbonate, ammonium bicarbonate, and hydrochloric acid, are produced. Ammonia is generated by reacting an ammonium salt with either acidic or basic materials. Non-limiting examples of suitable ammonium salt include ammonium chloride, ammonium sulfate, ammonium bisulfate, and ammonia nitrate, those of the acidic material include ammonium bisulfate and sulfuric acid, and those of the basic material include calcium oxide, limestone, dolomite, cement kiln dust, calcium-rich fly ash, steel and iron slag, and silicate rocks or mining wastes that are rich in serpentine, olivine or wollastonite.

### CROSS-REFERENCE TO RELATED APPLICATIONS

This patent claims priority to U.S. Provisional Patent Applications No. 61/234,195, filed on Aug. 14, 2009, No. 61/264,691, filed on Nov. 26, 2009, and No. 61/289,876, filed on Dec. 23, 2009, the disclosure of which are hereby incorporated by reference in their entirety for any purpose.

### STATEMENT REGARDING FEDERALLY SPONSORED RESEARCH OR DEVELOPMENT

Not applicable.

### BACKGROUND OF THE INVENTION

This invention relates generally to a method for removing carbon dioxide (CO₂) from a volume or stream of CO₂-bearing gas and sequestering the removed CO₂ in stable bicarbonate and/or carbonate. More particularly, this invention relates to a method for sequestering CO₂ comprising reacting an ammonium salt with either acidic or basic materials to generate ammonia, dissolving the generated ammonia in a recycled aqueous solution to produce a basic ammoniated solution, and reacting the basic ammoniated solution with the CO₂-bearing gas to remove at least a portion of CO₂ from a volume or stream of CO₂-bearing gas, precipitate the removed CO₂ as bicarbonate and produce the recycled aqueous solution.

Various anthropogenic activities such as energy production by fossil fuel burning release large quantities of CO₂ (and other acidic gases such as SO₂ and HCl) to the atmosphere. In the year 2006, for example, the total anthropogenic CO₂ emission to the atmosphere was estimated at about 29.22 billion metric tons. About half of the anthropogenic CO₂ emission to the atmosphere remains in the atmosphere, resulting in a rapid and steady increase in atmospheric CO₂ concentration, from an estimated pre-industrial level of 280 ppmv (parts per million by volume) to a measured value of 384 ppmv in 2008. Carbon dioxide is an important greenhouse gas. This increase in atmospheric CO₂ concentration is believed to have caused global climate change or global warming and surface ocean acidification. Recognizing that climate change is one of the greatest challenges of our time, the United Nations Framework Convention on Climate Change (Copenhagen Accord, 2009) has set a common goal of keeping the increase in global temperature below 2° C. to avoid the risk of devastating effects. It is generally agreed by the scientific community that to reach this goal, global greenhouse gas emissions need to be cut by at least 50% of 1990 levels (global CO₂ emission: 6.10 GtC/yr or 22.37 billion metric tons of CO₂) by 2050.

Eighty percent of the world's energy is derived from fossil fuel and the Earth has abundant fossil fuel reserves, particularly coal. Considering that there are still no alternative forms or sources of energy that could replace our heavy reliance on fossil fuel in the near future, it is vital and urgent that new practical, cost-effective and environmentally sound CO₂ sequestration methods be developed so that we can reduce anthropogenic CO₂ emissions to the atmosphere while keeping using fossil fuel to fulfill our energy needs.

There has been intensive research on various potential methods. The Intergovernmental Panel on Climate Change (IPCC) gave a comprehensive summary on CO₂ capture and storage (CCS) techniques (IPCC Special Report on Carbon Dioxide Capture and Storage, Cambridge University Press: Cambridge, 2005) and the Royal Society provided an overview on carbon dioxide removal (CDR) techniques (Geoengineering the Climate: Science, governance and uncertainty. The Royal Society, London, 2009). It is apparent that various techniques exist but none is sufficiently practical, cost-effective and environmentally sound for full scale implementation. Furthermore, considering the sheer volume of CO₂ emissions to be reduced, it is obvious that we will need to deploy all the practical, cost-effective and environmentally sound techniques or methods that we can come up with. The present invention is directed to providing such a method or technique.

### SUMMARY OF THE INVENTION

The present invention is directed to a method for sequestering CO₂ in which an ammonium salt is used to generate ammonia that is then used to enhance CO₂ dissolution in aqueous solutions and transfer the dissolved CO₂ to the more stable bicarbonate forms. Various valuable byproducts are produced to render the process cost-effective. One embodiment of the present invention comprises the main steps of: (1) generating ammonia from an ammonium salt, (2) dissolving the generated ammonia in a recycled aqueous solution to make a basic ammoniated solution, and (3) removing at least a portion of CO₂ from a volume or stream of CO₂-bearing gas and precipitating the removed CO₂ as ammonium bicarbonate using the basic ammoniated solution, whereby resulting in a CO₂-depleted gas and the recycled aqueous solution. An alternative embodiment of the present invention comprises the main steps of: (1) generating ammonia from a recycled ammonium salt, (2) dissolving the generated ammonia and a sodium salt in a recycled ammonium salt solution to produce a basic ammoniated sodium salt solution and precipitate the ammonium salt, and (3) removing at least a portion of CO₂ from a volume or stream of CO₂-bearing gas and precipitating the removed CO₂ as sodium bicarbonate using the basic ammoniated sodium salt solution, whereby resulting in a CO₂-depleted gas and the recycled ammonium salt solution. The precipitated sodium bicarbonate may further be calcinated to sodium carbonate and disposed to certain area of the surface ocean to mitigate local ocean acidification and enhance oceanic uptake of atmospheric CO₂.

Ammonia is generated from an ammonium salt by various reactions between the ammonium salt and either acidic or basic materials. Non-limiting examples of the ammonium salt include ammonium chloride, ammonium sulfate, ammonium bisulfate, ammonium nitrate, ammonium carbonate, ammonium bicarbonate, and ammonium phosphate. The acidic material includes but not limited to ammonium bisulfate, sodium bisulfate and sulfuric acid. Suitable basic materials include various natural oxide, carbonate and silicate minerals, rocks, or mining wastes and industrial byproducts or wastes. Non-limiting examples of such basic materials include calcium oxide, limestone, dolomite, cement kiln dust, CaO-rich fly ash, steel and iron slag, and silicate rocks or mining wastes that are rich in serpentine, olivine or wollastonite.

An objective of the present invention is a practical method for sequestering CO₂ from a volume or stream of CO₂-bearing gas, particularly flue gases of fossil fuel combustion power plants and industrial processes. Another objective is a cost-effective method for sequestering CO₂ in which the reactants are relatively abundant and inexpensive, the products are valuable, and the energy consumption and waste production are low. A further objective is an environmentally sound method for sequestering CO₂ in which CO₂ is sequestered in stable and environmentally benign bicarbonate or carbonate and no adverse effect or risk to the environment is produced. A further objective is a method that can be retrofitted to existing technologies or incorporated into new industrial designs. A further objective is a method that can simultaneously sequester other acidic pollutants. A further objective is a method that can be extended to mitigate local surface ocean acidification and enhance oceanic uptake of atmospheric CO₂.

The foregoing is intended as a broad summary only and of only some of the aspects of the invention. It is not intended to define the limits or requirements of the invention. These and other features, aspects, and advantages of the present invention will become better understood with reference to the following description and claims.

### DESCRIPTION OF THE DRAWINGS

The present invention may be better understood by reference to one or more of the drawings in combination with the description of the illustrative embodiments presented herein:

FIG. 1 is a simplified illustration of the chemical weathering of silicate and carbonate minerals and rocks as a key natural process of atmospheric CO₂ sequestration;

FIG. 2 is a schematic representation of an overview of the present invention;

FIG. 3 is a schematic representation of another overview of the present invention;

FIG. 4 is a schematic representation of an embodiment of the present invention;

FIG. 5 is a schematic representation of another embodiment of the present invention;

FIG. 6 is a schematic representation of an embodiment of the present invention for generating ammonia for CO₂ sequestration;

FIG. 7 is a schematic representation of another embodiment of the present invention for generating ammonia for CO₂ sequestration;

FIG. 8 is a schematic representation of a further embodiment of the present invention for generating ammonia for CO₂ sequestration; and

FIG. 9 is a schematic representation of a preferred embodiment of the present invention for generating ammonia for CO₂ sequestration.

### DESCRIPTION OF ILLUSTRATIVE EMBODIMENTS

The following detailed description includes an explanation of one or more embodiments that illustrates the inventive concept. It will be understood that these embodiments are presented as examples and are not meant to limit the scope of the invention in any manner. The descriptions of the present methods and devices are exemplary and non-limiting. Certain substitutions, modifications, additions and/or rearrangements falling within the scope of the claims, but not explicitly listed in this disclosure, may become apparent to those skilled in the art based on this disclosure.

Descriptions of processing techniques, components, and equipment well-known in the art are omitted in certain cases so as not to unnecessarily obscure the present methods and devices in unnecessary detail.

### Inventive Concept of the Present Invention

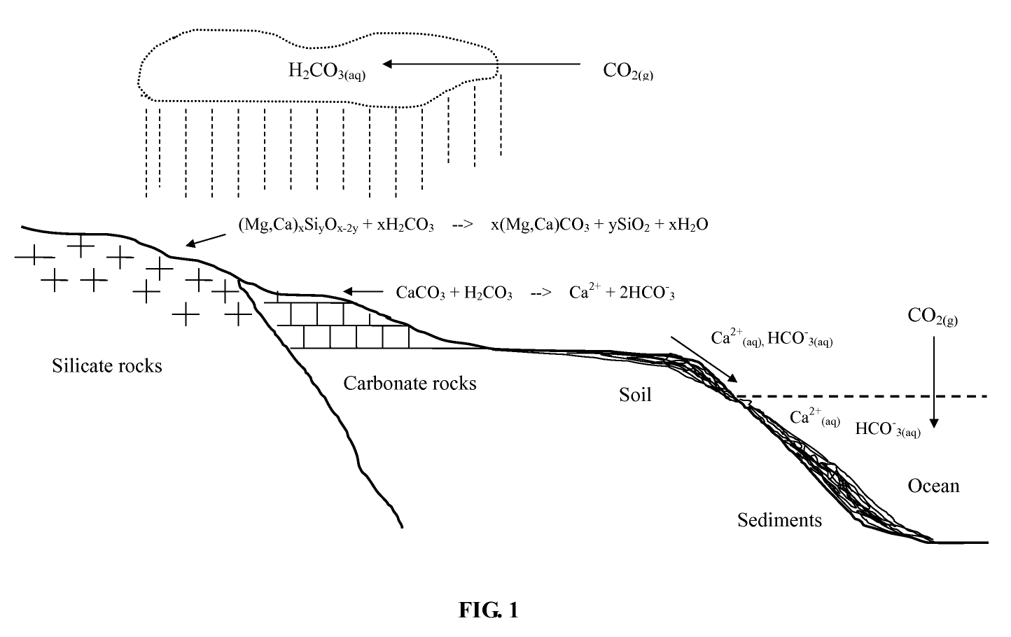

Chemical weathering of minerals and rocks is one of the most important natural processes that regulate the Earth's atmospheric CO₂ concentration on geological time scales (R. A. Berner, A. C. Lasaga, and R. M. Garrels, “The Carbonate-Silicate Geochemical Cycle and its Effect on Atmospheric Carbon Dioxide Over the Last 100 Million Years”, American Journal of Science, Vol. 293, p 42-50, 1983). FIG. 1 is an illustrative description of this process. Atmospheric CO₂ is dissolved in rainwater and surface freshwater to form a weak carbonic acid. Because of carbonic acid formation, rainwater is slightly acidic, with a pH value usually below 5.6. Chemical weathering occurs when the carbonic acid in rainwater or surface freshwater is reacted with silicate or carbonate minerals or rocks:

(Mg,Ca)ₓSi_{y}O_{x-2y}+xH₂CO₃−>x(Mg,Ca)CO₃+ySiO₂+xH₂O CaCO₃+H₂CO₃−>Ca²⁺+2HCO⁻₃

Solid products of weathering form soils and sediments and most of the dissolved species are carried eventually to the ocean by surface water and groundwater. Through chemical weathering, atmospheric CO₂ is sequestered in stable carbonate minerals or dissolved bicarbonate ions. As the Earth contains abundant quantities of silicate and carbonate minerals or rocks, chemical weathering processes are expected to eventually consume most of the anthropogenic CO₂ emissions. The problem however is that such natural processes occur on the order of over 1,000 year time scales and thus will have little immediate impact on the rapidly increasing CO₂ emissions and atmospheric CO₂ burden in the coming decades or centuries. The extremely low solubility of CO₂ in natural water and the extremely slow reaction rates between carbonic acid and silicate or carbonate minerals or rocks are two of the most important factors that hinder these processes.

The present invention can be regarded as a chemical engineering method or technique that accelerates drastically the rates of these chemical weathering processes and consequently speed up nature's way of sequestering CO₂ from geological time scale to industrial time scale. In particular, the present invention uses ammonia to increase CO₂ solubility in aqueous solutions, transfer the dissolved CO₂ to the more stable bicarbonate forms, and regenerate ammonia from ammonium salts using some of nature's silicate and carbonate minerals or rocks, as well as some industrial wastes.

### Overview of the Present Invention

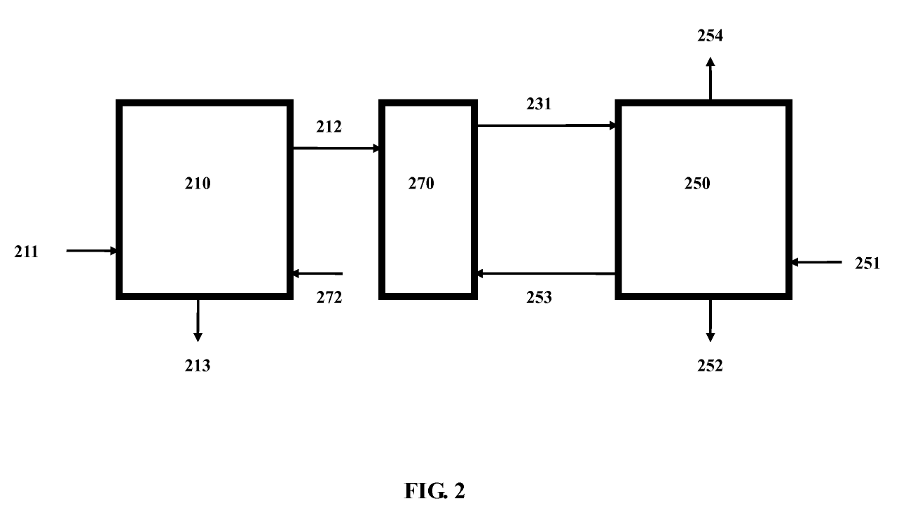

FIG. 2 is a schematic representation of an integrated overview of the present invention, comprising the steps of: (a) generating ammonia 212 from an ammonium salt 272 in an ammonia generation device 210, (b) dissolving the generated ammonia 212 in a recycled aqueous solution 253 in a gas absorption device 270 to produce a basic ammoniated solution 231 and (c) removing at least a portion of CO₂ from a volume or stream of CO₂-bearing gas 251 and precipitating the removed CO₂ as bicarbonate 252 using the basic ammoniated solution 231 in a carbonation device 250, whereby resulting in a CO₂-depleted gas 254 and the recycled aqueous solution 253. In the present invention, there are several different means to generate ammonia from an ammonium salt, which will be described in detail in followed embodiments. In general, ammonia 212 is generated by reacting an ammonium salt 272 with either acidic or basic materials 211 in the ammonia generation device 210. The ammonium salt 272 is preferably ammonium chloride but can also be other ammonium salts, including but not limited to ammonium sulfate, ammonium bisulfate, ammonium carbonate, ammonium bicarbonate, ammonium nitrate, and ammonium phosphate. The acidic material is preferably ammonium bisulfate but can also be sodium bisulfate and sulfuric acid. Suitable basic materials include various natural oxide, carbonate and silicate minerals, rocks or mining wastes and industrial byproducts or wastes. Examples of such basic materials include but not limited to calcium oxide, limestone, dolomite, cement kiln dust, CaO-rich fly ash, steel and iron slag, and silicate rocks or mining wastes that are rich in serpentine, olivine or wollastonite. Various valuable byproducts 213 are coproduced with ammonia generation.

The generated ammonia 212 is dissolved in the recycled aqueous solution 253 at temperature preferably below about 40° C. and under ambient pressure in the gas absorption device 270 to produce the basic ammoniated solution (or ammonium hydroxide solution in equivalent) 231.

The volume or stream of CO₂-bearing gas 251 is reacted with the basic ammoniated solution 231 in the carbonation device 250 to remove at least a portion of CO₂ from the CO₂-bearing gas 251 and precipitate the removed CO₂ as ammonium bicarbonate 252, resulting in a CO₂-depleted gas 254 that can be released to the atmosphere. The carbonation device 250 is preferably designed for optimal gas-liquid contact and may consist of either one reactor or a series of connected reactors, applying the lasted gas-liquid reaction technology in the art. The reactions between the CO₂-bearing gas 251 and the basic ammoniated solution 231 are preferably carried out at temperatures below about 40° C. and under pressures in the range of about 100 kPa (ambient pressure) to about 400 kPa. The precipitated ammonium bicarbonate 252 is removed and the solution 253 is transferred to the gas absorption device 270 to regenerate the basic ammoniated solution 231.

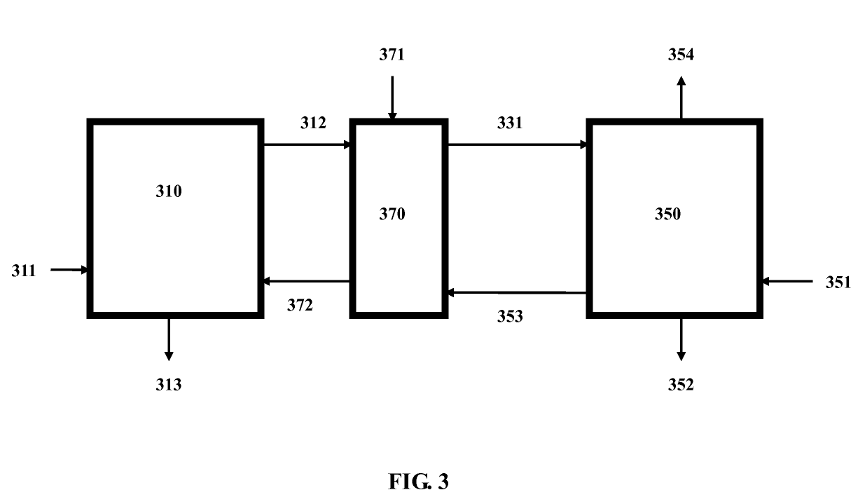

FIG. 3 is a schematic representation of another integrated overview of the present invention, comprising the steps of: (a) generating ammonia 312 from a recycled ammonium salt 372 in an ammonia generation device 310, (b) dissolving the generated ammonia 312 and a sodium salt 371 in a recycled ammonium salt solution 353 in a gas absorption device 370 to produce a basic ammoniated sodium salt solution 331 and the recycled ammonium salt 372, and (c) removing at least a portion of CO₂ from a volume or stream of CO₂-bearing gas 351 and precipitating the removed CO₂ as sodium bicarbonate 352 using the basic ammoniated sodium salt solution 331 in a carbonation device 350, whereby resulting in a CO₂-depleted gas 354 and the recycled ammonium salt solution 353.

In this embodiment according to the present invention, ammonia 312 is generated by reacting the recycled ammonium salt 372 with either acidic or basic materials 311 in the ammonium generation device 310, applying any of the means to be disclosed in followed embodiments. The recycled ammonium salt 372 is preferably ammonium chloride and can also be, but not limited to, ammonium sulfate and ammonium nitrate.

The generated ammonia gas 312 and the sodium salt 371 are dissolved in the recycled ammonium salt solution 353 at temperatures preferably below about 40° C. and under ambient pressure in the gas absorption device 370 to produce the basic ammoniated sodium salt solution 331 and precipitate the recycled ammonium salt 372, which is removed from the basic ammoniated sodium salt solution 331 and recycled for ammonia generation. The sodium salt 371 is preferably sodium chloride and can also be other salts, such as sodium sulfate and sodium nitrate.

The volume or stream of CO₂-bearing gas 351 is reacted with the basic ammoniated sodium salt solution 331 in the carbonation device 350 to remove at least a portion of CO₂ from the CO₂-bearing gas 351 and precipitate the removed CO₂ as sodium bicarbonate 352, resulting in the CO₂-depleted gas 354 that can be released to the atmosphere. The carbonation device 350 is preferably designed for optimal gas-liquid contact and may consist of either one reactor or a series of connected reactors, applying the lasted gas-liquid technology in the art. The reactions between the CO₂-bearing gas 351 and the basic ammoniated sodium salt solution 331 are preferably carried out at temperatures below about 60° C. and under pressures in the range of about 100 kPa to about 400 kPa. The precipitated sodium bicarbonate 352 is removed and the ammonium salt solution 353 is recycled.

### Illustrative Embodiments According to the Present Invention:

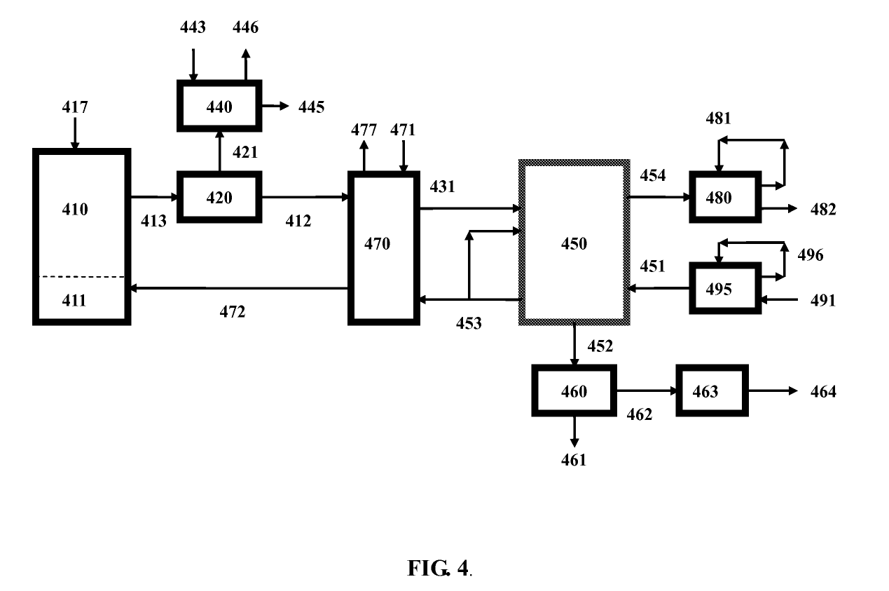

FIG. 4 is a schematic representation of a preferred embodiment according to the present invention. In this embodiment, ammonia 412 is generated from a recycled ammonium chloride 472 through a two-stage thermal decomposition process. First, solid ammonium bisulfate is placed in a thermal decomposition device 410 and heated to a temperature in the range of above the melting point of ammonium bisulfate (about 147° C.) and below the melting or decomposition point of ammonium sulfate (about 280° C.), preferably between about 200° C. and about 260° C., and under ambient pressure, to obtain molten ammonium bisulfate 411. The recycled ammonium chloride 472 is admixed to the molten ammonium bisulfate 411 with a mole ratio between about 0.2 and about 1.0, preferably between about 0.3 and about 0.5, to produce ammonium sulfate and hydrochloric gas:

NH₄Cl+NH₄HSO₄−>(NH₄)₂SO₄+HCl(g)

This reaction may preferably be accelerated by various means of agitation well-known in the art and by removing the generated hydrochloric gas from the decomposition device 410, preferably by passing an inert carrying gas 417 through the decomposition device 410. The HCl-bearing exit gas 413 is cooled, preferably to below about 100° C., in a cold trap device 420 to eliminate ammonia. The NH₃-depleted gas 421 is then reacted with cold water 443 in a first gas absorption device 440 to form concentrated hydrochloric acid 445. The HCl-free gas 446 is either recycled or released to the atmosphere. The concentrated hydrochloric acid 445 is preferably marketed as industrial product. At the second thermal decomposition stage, the temperature in the thermal decomposition device 410 is further increased to above the melting or decomposition point of ammonium sulfate (about 280° C.) and below the decomposition point of ammonium bisulfate (about 380° C.), preferably between about 320° C. and about 380° C., and under ambient pressure. Ammonium sulfate melts, releases ammonia gas and converts back to ammonium bisulfate:

(NH₄)₂SO₄−>NH₄HSO₄+NH₃(g)

This reaction is preferably accelerated by various means of agitation well-known in the art, by heating the melts at a fast rate, preferably faster than 60° C./min, and by removing the generated ammonia from the thermal decomposition device 410, preferably by passing the inert carrying gas 417 through the thermal decomposition device 410. The NH₃-bearing exit gas 413 is cooled, preferably below about 100° C., in the cold trap device 420 to eliminate any hydrochloric gas. The HCl-depleted gas 412 then flows to a second gas absorption device 470 in which its ammonia is dissolved in a recycled ammonium chloride solution 453. The NH₃-free inert gas 477 exits the second gas absorption device 470 and is either recycled or released to the atmosphere. In the second stage, ammonium sulfate is either partially or completely converted to ammonium bisulfate and ammonia. The thermal decomposition device 410 is then cooled down to below the melting or decomposition point of ammonium sulfate (about 280° C.) and another batch of the recycled solid ammonium chloride 472 is added to start another hydrochloric gas and ammonia generation cycle.

After absorbing ammonia from the HCl-depleted gas 412, solid sodium chloride 471 is added to the recycled ammonium chloride solution 453 in the second gas absorption device 470 to precipitate the recycled ammonium chloride 472 and produce a basic ammoniated sodium chloride solution 431. The ammonia absorption, sodium chloride dissolution and ammonium chloride precipitation reactions are preferably carried out at temperatures below about 40° C.; cooling may be required, preferably through cold water circulation, refrigeration, evaporation under vacuum, or other means well-known in the art. The precipitated ammonium chloride 472 is removed from the solution, preferably by filtration or centrifuge, and recycled for ammonia generation.

A volume or stream of CO₂-bearing gas 451 is reacted with the basic ammoniated sodium chloride solution 431 to remove at least a portion of CO₂ from the CO₂-bearing gas 451 and precipitate the removed CO₂ as sodium bicarbonate 452 in a carbonation device 450:

CO₂(g)+NH₃(aq)+H₂O+Na⁺−>NaHCO₃(s)+NH₄⁺

It is to note that the rate of this gas-liquid reaction determines the level of CO₂ removal from the CO₂-bearing gas 451. High level of CO₂ removal may be achieved through maximizing gas-liquid contact through spraying or atomizing the basic ammoniated sodium chloride solution 431, by using a basic ammoniated sodium chloride solution 431 that is both ammonia and sodium chloride saturated, through reducing system temperature and increasing system pressure, and by prolonging gas residence time and/or reducing gas/liquid ratio in the carbonation device 450. The carbonation device 450 is preferably designed for optimal gas-liquid contact and may consist of either one reactor or a series of connected reactors, applying the lasted gas-liquid technology in the art. In addition, decisions on desired level of CO₂ removal and device design should also take into consideration of capital cost, energy consumption, and operational expenses. In general, the above gas-liquid reactions are preferably carried out in the carbonation device 450, in which the basic ammoniated sodium chloride solution 431 is atomized and sprayed from the top countercurrent to the CO₂-bearing gas 451 that rises from near the bottom. The basic ammoniated sodium chloride solution 431 is preferably near saturation with respect to both ammonia and sodium chloride. In the carbonation device 450, reaction temperatures are preferably maintained at below about 60° C. and pressures in the range of about 100 kPa (ambient pressure) to about 400 kPa. After CO₂ removal, a CO₂-depleted gas 454 exits the carbonation device 450, goes through a cold water and/or acidic solution 481 wash in a third gas absorption device 480 to remove residual ammonia. An NH₃-free and CO₂-depleted gas 482 is released to the atmosphere. The precipitated sodium bicarbonate 452 is removed from the solution, preferably by filtration or centrifuge, and marketed as industrial product, stored on land, or disposed to the ocean. The solution 453, which is NH₄Cl-rich, is recycled: part of it is transferred to the second gas absorption device 470 to precipitate the ammonium chloride 472 and regenerate the basic ammoniated sodium chloride solution 431, the rest is circulated directly to the top of the carbonation device 450 to react directly with the CO₂-bearing gas 451. The regeneration rate of the basic ammoniated sodium chloride solution 431 from the ammonium chloride solution 453 is preferably set so that the solution in the carbonation device 450 is always undersaturated with respect to ammonium chloride.

If the CO₂-bearing gas to be treated is hot (above 60° C.) and/or contains significant quantities of strong acidic gases (e.g., SO₂, HCl), such as flue gases of coal combustion power plants that have no desulfurization system, a cooling step is preferred, in which cold water or a cold basic solution 496 is sprayed to the hot CO₂-bearing gas 491 in a gas washing device 495 to reduce its temperature to below about 60° C. and to clean it off the strong acidic gases and particles prior to CO₂ sequestration.

If sodium carbonate production is desired, the produced sodium bicarbonate 452 may optionally be decomposed at temperatures in the range of about 160° C. to about 230° C. in a calcination device 460:

2NaHCO₃(s)−>Na₂CO₃(s)+CO₂(g)+H₂O(g)

The produced sodium carbonate 461 is preferably either marketed as an industrial product or disposed to a body of seawater of the ocean, particularly in areas of ecological importance, to mitigate acidification of the body of seawater, as well as to enhance oceanic uptake of atmospheric CO₂ at the ocean-atmosphere interface:

Na₂CO₃+CO₂(g)+H₂O→2Na⁺+2HCO⁻₃

The addition of one mole of sodium carbonate to the surface ocean absorbs proximately one mole of CO₂ from the atmosphere within a short period of time (less than a year). The relatively pure CO₂ gas 462 is preferably collected after passing through a moisture removing device 463 and marketed as an industrial product 464.

In this embodiment, CO₂ sequestration is achieved using sodium chloride as raw material and thermal and electrical energies as driving forces. Ammonia, ammonium chloride and aqueous solutions are recycled. Sodium bicarbonate (or sodium carbonate) and hydrochloric acid are produced. No large quantity of waste is generated. The whole process can be summarized by an overall chemical reaction:

CO₂(g)+NaCl(s)+H₂O−>NaHCO₃(s)+HCl

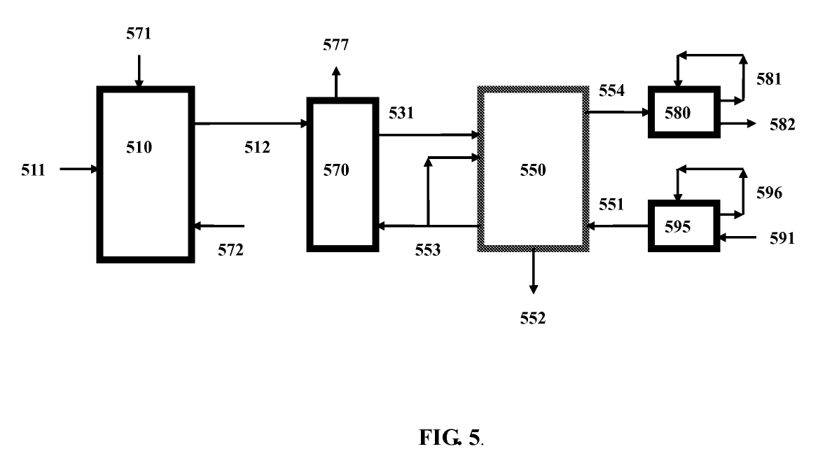

FIG. 5 is a schematic representation of an alternative embodiment according to the present invention. In this embodiment, solid ammonium sulfate 572, an industrial byproduct and nitrogen fertilizer, is first heated to temperatures above its melting or decomposition point (about 280° C.) and below the decomposition point of ammonium bisulfate (about 380° C.), preferably between about 320° C. and about 380° C. in an ammonia generation device 510 to generate ammonia:

(NH₄)₂SO₄−>NH₄HSO₄+NH₃(g)

This reaction is preferably accelerated by various means of agitation well-known in the art, by heating the melts at a fast rate, preferably faster than 60° C./min, and by removing the generated ammonia from the thermal decomposition device 410. An inert carrying gas 571 passes through the ammonia generation device 510 to remove the generated ammonia. An NH₃-bearing gas 512 then flows to a first gas absorption device 570 in which its ammonia is dissolved in a recycled aqueous solution 553. An NH₃-free inert gas 577 exits the gas absorption device 570 and is either recycled or released to the atmosphere. After most of the ammonium sulfate 572 is converted to ammonium bisulfate, a serpentine-rich material 511 is then added to the ammonia generation device 510 to react with the produced ammonium bisulfate to generate more ammonia:

3NH₄HSO₄+Mg₃Si₂O₅(OH)₄(s)−>3MgSO₄+2SiO₂₍ₛ₎+3NH₃(g)+5H₂O

Serpentine is an abundant group of ultramafic silicate minerals on the Earth and can usually be represented by a chemical formula Mg₃Si₂O₅(OH)₄ or more generally by X₂₋₃Si₂O₅(OH)₄, where X is selected from the group consisting of Mg, Ca, Fe²⁺, Fe³⁺, Ni, Al, Zn, and Mn. It is to note that other silicate minerals or rocks or mining wastes, including but not limited to those that are rich in olivine or wollastonite, can also be used in similar manners as serpentine to generate ammonia. The inert carrying gas 571 passes preferably through the ammonia generation device 510 to remove the generated ammonia. The NH₃-bearing gas 512 then flows to the first gas absorption device 570 in which its ammonia is dissolved in the recycled aqueous solution 553. The NH₃-free inert gas 577 exits the first gas absorption device 570 and is either recycled or released to the atmosphere.

Ammonia dissolution in the recycled aqueous solution 553 in the first gas absorption device 570 produces a basic ammoniated solution (or ammonium hydroxide solution, in equivalent) 531. This ammonia dissolution reaction is preferably carried out at temperatures below about 40° C. and under ambient pressure; cooling may be required, preferably through cold water circulation, refrigeration, evaporation under vacuum, or other means well-known in the art.

A volume or stream of CO₂-bearing gas 551 is reacted with the basic ammoniated solution 531 in a carbonation device 550 to remove at least a portion of CO₂ from the CO₂-bearing gas 551 and precipitate the removed CO₂ as ammonium bicarbonate 552:

CO₂(g)+NH₃(aq)+H₂O−>NH₄HCO₃(s)

It is to note that the rate of this gas-liquid reaction determines the level of CO₂ removal from the CO₂-bearing gas 551. High level of CO₂ removal may be achieved through maximizing gas-liquid contact through atomizing or spraying the basic ammoniated solution 531, by reducing system temperature and increasing system pressure, and by prolonging gas residence time and/or reducing gas/liquid ratio in the carbonation device 550. The carbonation device 550 is preferably designed for optimal gas-liquid contact and may consist of either one reactor or a series of connected reactors, applying the lasted gas-liquid technology in the art. In addition, decisions on desired level of CO₂ removal and device design should also take into consideration of capital cost, energy consumption, and operational expenses. In general, the above gas-liquid reactions are preferably carried out in the carbonation device 550, in which the basic ammoniated solution 531 is atomized and sprayed from the top countercurrent to the CO₂-bearing gas 551 that rises from near the bottom. The basic ammoniated solution 531 is preferably near saturation with respect to ammonia. In the carbonation device 550, reaction temperatures are preferably maintained at below about 40° C. and pressures in the range of about 100 kPa (ambient pressure) to about 400 kPa. After CO₂ removal, a CO₂-depleted gas 554 exits the carbonation device 550, goes through a cold water and/or acidic solution 581 wash in a second gas absorption device 580 to remove residual ammonia. An NH₃-free and CO₂-depleted gas 582 is released to the atmosphere. The precipitated ammonium bicarbonate 552 is removed from the aqueous solution 553, preferably by filtration or centrifuge. The aqueous solution 553 is recycled: part of it is transferred to the first gas absorption device 570 to dissolve ammonia 512 to regenerate the basic ammoniated solution 531, the rest is circulated directly to the top of the carbonation device 550 to react with the CO₂-bearing gas 551. The regeneration rate of the basic ammoniated solution 531 from the aqueous solution 553 is preferably set so that solution in the carbonation device 550 is always basic, with a pH value above about 8.0. The produced ammonium bicarbonate 552 is preferably marketed as a nitrogen and carbon fertilizer, particularly for greenhouse agriculture. A recent study by Cheng et al (“Investigation of Carbon Distribution with ¹⁴C as Tracer for Carbon Dioxide Sequestration through NH₄HCO₃” Energy & Fuels, Vol. 21, pp. 3334-3340. 2007) indicated that when ammonium bicarbonate was applied as a nitrogen and carbon fertilizer in greenhouse agriculture, up to 10% of the carbon was transferred to biomass and up to 76% of the carbon was locked in the soil as environmentally benign calcium carbonate.

If the CO₂-bearing gas to be treated is hot (above 60° C.) and/or contains significant quantities of strong acidic gases (e.g., SO₂, HCl), such as flue gases of coal combustion power plants that have no desulfurization system, a cooling step is preferred, in which cold water or a cold basic solution 596 is sprayed to the hot CO₂-bearing gas 591 in a gas washing device 595 to reduce its temperature to below about 60° C. and to clean it off the strong acidic gases and particles prior to CO₂ sequestration.

In this embodiment according to the present invention, ammonium sulfate, an industrial byproduct that has been used as a nitrogen fertilizer, is used as raw material to generate ammonia to sequester CO₂ and produce ammonium bicarbonate, another nitrogen and carbon fertilizer that is particularly preferred by greenhouse agriculture. Other ammonium salts or fertilizers, including but not limited to ammonium chloride ammonium nitrate and ammonium phosphate, can also be used to generate ammonia in similar manners as that of ammonium sulfate.

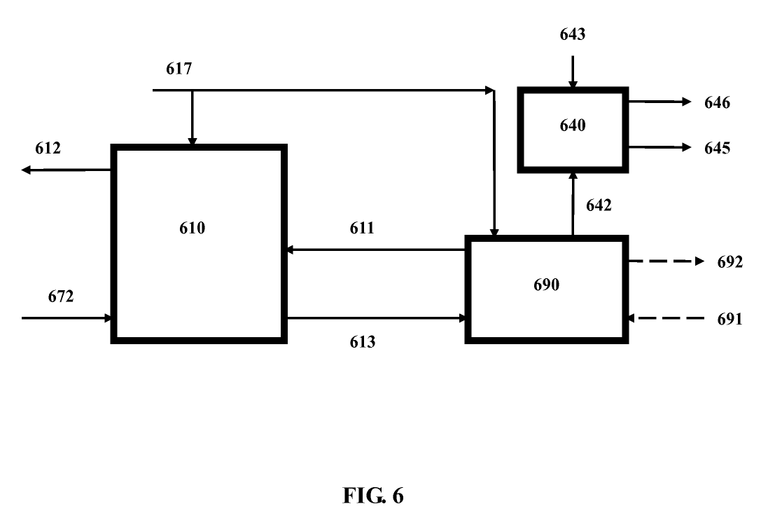

FIG. 6 is a schematic representation of an embodiment of the present invention for generating ammonia for CO₂ sequestration. In this embodiment, ammonium chloride 672 is reacted with calcium oxide (or quicklime, in equivalent) 611 in slurry, preferably with a mole ratio under about 2.0, to generate ammonia 612 in an ammonia generation device 610:

2NH₄Cl+CaO(s)−>CaCl₂+2NH₃(g)+H₂O

This reaction may preferably be enhanced by various means of agitation well-known in the art and by heating, preferably using low grade waste thermal energy. Ammonia 612 is removed from the ammonia generation device 610, preferably by an inert carrying gas 617 and is used for CO₂ sequestration according to the present invention.

The produced calcium chloride 613 is either marketed as an industrial product or used to reproduce calcium oxide 611 for another cycle of ammonia generation. In the later case, calcium chloride 613 is heated to above the melting point of calcium chloride (about 800° C.) in a thermal decomposition device 690:

CaCl₂+H₂O−>CaO(s)+2HCl(g)

This reaction may preferably be enhanced by removing hydrochloric gas from the thermal decomposition device 690 with the inert carrying gas 617. A HCl-bearing gas 642 is reacted with water 643 in a gas absorption device 640 to form a concentrated hydrochloric acid 645. A HCl-free inert gas 646 is either recycled or released to the atmosphere. The produced calcium oxide 611 is recycled back to the ammonia generation device 610 for ammonia generation. The produced concentrated hydrochloric acid 645 is preferably marketed as an industrial product.

In an alternative embodiment according to the present invention, calcium chloride 613 is burnt in the presence of oxygen gas 691 (for example, air), preferably at temperatures greater than 600° C., to generate calcium oxide 611 and a chlorine gas 692.

CaCl₂+½O₂(g)−>CaO(s)+Cl₂(g)

The produced chlorine gas 692 is collected from the decomposition device 690 and preferably marketed as an industrial product.

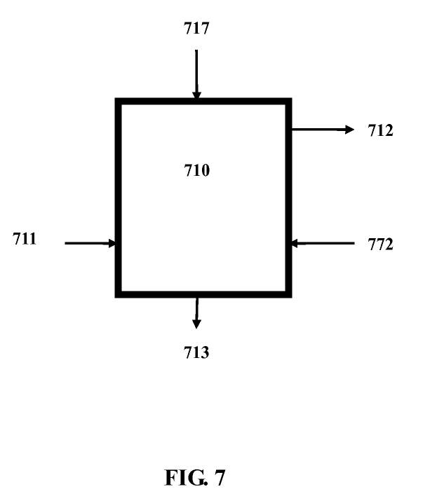

FIG. 7 is a schematic representation of another embodiment of the present invention for generating ammonia for CO₂ sequestration. In this embodiment, ammonia is generated from reacting an ammonium salt with a basic CaO-rich waste material. The ammonium salt includes, but not limited to, ammonium chloride, ammonium sulfate, ammonium bisulfate, ammonium nitrate, ammonium carbonate, ammonium bicarbonate and ammonium phosphate. The basic CaO-rich waste material includes, but not limited to, cement kiln dust, CaO-rich fly ash, waste concrete, and steel and iron slag. This ammonia generation process is illustrated hereunder using the reactions between ammonium carbonate and cement kiln dust. It is to note that similar processes apply to other ammonium salts and CaO-rich waste materials. Referring to FIG. 7, ammonium carbonate 772 is reacted with cement kiln dust 711 in slurry, preferably with an overall NH₄ to CaO mole ratio of about 2.0, to generate ammonia 712 in an ammonia generation device 710:

(NH₄)₂CO₃+CaO(s)−>CaCO₃(s)+2NH₃(g)+H₂O

This reaction may preferably be enhanced by various means of agitation well-known in the art and by heating, preferably using low grade waste thermal energy. The generated ammonia 712 is removed from the ammonia generation device 710, preferably by an inert carrying gas 717, and is used for CO₂ sequestration according to the present invention. At the end of ammonia generation process, waste produced 713 is removed from the ammonia generation device 710.

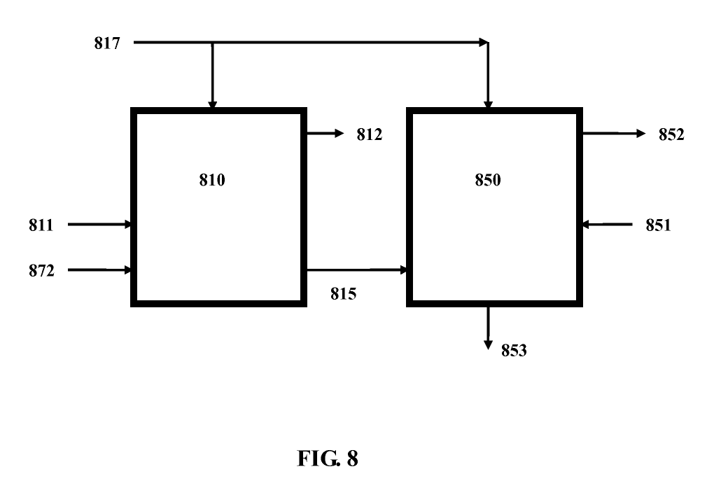

FIG. 8 is a schematic representation of a further embodiment of the present invention for generating ammonia for CO₂ sequestration. In this embodiment, ammonia is generated from reacting ammonium chloride or ammonium bisulfate with limestone and a basic CaO-rich waste material. Ammonium chloride is chosen to illustrate the process hereunder. Ammonium chloride 872 is reacted with limestone (or calcium carbonate, in equivalent) 811 in slurry in a first ammonia generation device 810:

2NH₄Cl+CaCO₃(s)−>CaCl₂+2NH₃(g)+CO₂(g)+H₂O

This reaction is preferably enhanced by various means of agitation well-known in the art, by heating, preferably to temperatures over about 60° C. using low grade waste thermal energy, and by using fine limestone particles. The generated gas 812, which contains about two moles of ammonia for every mole of CO₂, is removed from the first ammonia generation device 810, preferably by an inert carrying gas 817, and used for CO₂ sequestration according to the present invention. The resulting liquid 815, which contains dissolved calcium chloride and residual ammonium chloride, is then separated from the solid residual, which contains unreacted limestone, preferably by centrifuge or filtration, and transferred to a second ammonia generation device 850, where it is reacted with a CaO-rich waste material 851 to convert residual ammonium chloride to ammonia:

2NH₄Cl+CaO(s)−>CaCl₂+2NH₃(g)+H₂O

This reaction may preferably be enhanced by various means of agitation well-known in the art and by heating, preferably using low grade waste thermal energy. The generated ammonia is removed from the second ammonia generation device 850, preferably by the inert carrying gas 817. The NH₃-bearing gas 852 is used for CO₂ sequestration according to the present invention. The waste 853 is preferably used to produce calcium chloride.

Alternatively, other carbonates, such as dolomite, may also be applied in similar manner as limestone.

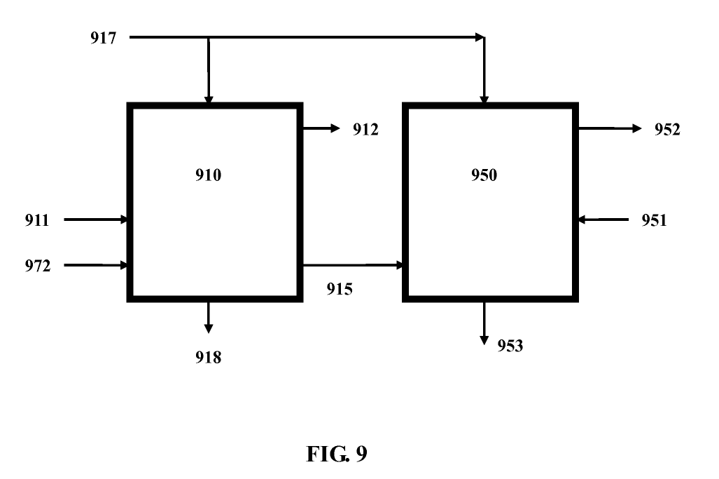

FIG. 9 is a schematic representation of a further embodiment of the present invention for generating ammonia for CO₂ sequestration. In this embodiment, ammonia is generated from reacting ammonium chloride or ammonium bisulfate with a silicate rock material first and then a basic CaO-rich waste material. The silicate rock material includes but not limited to rocks or mining wastes that are rich in serpentine, olivine, or wollastonite. The reactions between ammonium chloride and an olivine-rich rock are chosen to illustrate the process hereunder. Referring to FIG. 9, ammonium chloride 972 is reacted with an olivine-rich rock material 911 in slurry in a first ammonia generation device 910. Ammonia is generated according to the following reaction:

4NH₄Cl+(Mg,Fe)₂SiO₄(s)−>2(Mg,Fe)Cl₂+SiO₂(s)+4NH₃(g)+2H₂O

This reaction is preferably enhanced by various means of agitation well-known in the art, by heating, preferably to temperatures over about 60° C. using low grade waste thermal energy, and by using fine olivine-rich particles. Olivine is an abundant group of ultramafic silicate minerals on the Earth and can usually be represented by a chemical formula (Mg,Fe)₂SiO₄ or more generally by X₂SiO₄, where X is selected from the group consisting of Mg, Ca, Fe²⁺, Fe³⁺, Ni, Al, Zn, and Mn. It is to note that other silicate minerals or rocks or mining wastes, including but not limited to those that are rich in serpentine or wollastonite, can also be used to react with ammonium chloride to generate ammonia in similar manners as olivine. The generated ammonia is removed from the first ammonia generation device 910, preferably by an inert carrying gas 917. The NH₃-bearing gas 912 is used for CO₂ sequestration according to the present invention. The resulting liquid 915, which contains dissolved magnesium or iron chloride and residual ammonium chloride, is then separated from the solid residual, which contains unreacted olivine, silica and impurities, preferably by centrifuge or filtration, and transferred to a second ammonia generation device 950, where it is reacted with a CaO-rich waste material 951 to convert residual ammonium chloride to ammonia:

2NH₄Cl+CaO(s)−>CaCl₂+2NH₃(g)+H₂O

This reaction may preferably be enhanced by various means of agitation well-known in the art and by heating, preferably using low grade waste thermal energy. The generated ammonia is removed from the second ammonia generation device 950, preferably by the inert carrying gas 917. The NH₃-bearing gas 952 is used for CO₂ sequestration according to the present invention. The waste 918 from the first ammonia generation device 910 is preferably used to recover silica and the waste 953 from the second ammonia generation device 950 is preferably used to obtain magnesium, calcium and iron chlorides.

### Example

### Example 1

### Applying the Present Invention to Sequester CO₂ from Flue Gas of a 500 MW Coal Combustion Power Plant

According to International Energy Agency (IEA), coal provides 26.5% of global primary energy needs and generates 41.5% of the world's electricity. Coal combustion has been the most important source of anthropogenic CO₂ emission to the atmosphere. A typical flue gas of a coal combustion power plant without a desulfurization system and baghouse is hot (above 100° C.) and contains about 12-14 v % (volume percent) of CO₂, 13 v % of water vapor, 3 v % of O2, 70-72 v % of N₂, and minor quantities of SO₂ (up to 2,000 ppmv), SO₃, NOₓ (up to 200 ppmv), HCl and particulate matter.

In accordance with a preferred embodiment of the present invention, the hot flue gas is cooled to below about 60° C. using a cold and basic aqueous solution prior to CO₂ sequestration. Most of the strong acidic gases and particulate matter are removed. The cooled flue gas is reacted directly with a basic ammoniated sodium chloride solution in a carbonation device. At least a portion of CO₂ is removed from the flue gas. A desired degree of CO₂ removal is obtained through optimization of the carbonation device design and adjusting a number of key reaction parameters, including ammonia and sodium chloride concentrations in solution, reaction temperature and pressure, and gas residence time and gas/liquid ratio in the carbonation device. The removed CO₂ is precipitated as sodium bicarbonate and consequently sequestered from the atmosphere. The CO₂-depleted flue gas stream is released to the atmosphere after residual ammonia recovery. The solution is transferred to a gas absorption device after sodium bicarbonate removal through filtration or centrifuge. In the gas absorption device, the solution is cooled and ammonia gas and sodium chloride are dissolved in the cooled solution to precipitate ammonium chloride and to make up a basic ammoniated sodium chloride solution. The precipitated ammonium chloride is removed from the solution, by filtration or centrifuge, and sent to a thermal decomposition device to undergo a two-stage decomposition process in molten ammonium bisulfate to produce hydrochloric gas and ammonia. The hydrochloric gas dissolves in water to produce hydrochloric acid. The ammonia is recycled back to the gas absorption device to make the basic ammoniated sodium chloride solution for another cycle of flue gas CO₂ sequestration.

In accordance with this embodiment of the present invention, to sequester one mole of CO₂ from the flue gas, one mole of sodium chloride is consumed and one mole of sodium bicarbonate and one mole of hydrochloric gas are produced. A typical 500 MWe coal combustion power plant operating at full capacity with a 40% electric efficiency burns about 3,740 metric tons of low bituminous coal (energy content: 29.8 MJ/kg) and releases about 10,420 metric tons or 0.2367 million moles of CO₂ per day (24 hours). A 20% CO₂ removal from the flue gas will sequester 2,084 metric tons of CO₂ per day. It will consume 2,768 metric tons of sodium chloride and produce 3,979 metric tons of sodium bicarbonate and 1,727 metric tons of hydrochloric gas or 4,797 m³ of 36 wt % (weight percent) hydrochloric acid daily. On the other hand, a 90% CO₂ removal from the flue gas will sequester 9,378 metric tons of CO₂ per day. It will consume 12,456 metric tons of sodium chloride and produce 17,906 metric tons of sodium bicarbonate and 7,772 metric tons of hydrochloric gas or 21,586 m³ of 36 wt % hydrochloric acid daily.

Operational cost and energy consumption of the embodiment of the present invention are estimated with reference to that of the Solvay process and the Dual process of soda ash production (Hou T. P., “Manufacture of Soda”, Rheinhold Publishing Corp., New York, 1933; Hou T. P., “Soda Manufacture Engineering”, Chemical Industry Press, Beijing, 1960; IPCC BAT Reference Document, “Process BREF for Soda Ash”, European Soda Ash Producers Association, 2004; Sathaye et al., “Assessment of Energy Use and Energy Savings Potential in Selected Industrial Sectors in India”, Lawrence Berkeley National Laboratory, 2005). Table 1 summarizes the quantities of raw material, byproduct and waste in the production of one metric ton of soda ash or equivalent using the Solvay process, the Dual process and the present invention. It is apparent that the present invention compares favorably with both the Solvay process and the Dual process in terms of raw material consumption, produce and byproduct generation, and waste avoidance, in addition to fulfilling the intended task of CO₂ sequestration. Table 2 summarizes the energy consumptions of the Solvay process, the Dual process and the estimated values for the present invention. The energy consumption of ammonia generation of the present invention is estimated from that of limestone calcination of the Solvay process. In the Solvay process, limestone is calcinated at about 950-1100° C. following an endothermic reaction:

CaCO₃(s)−>CaO(s)+CO₂(g)−179 kJ

For every metric ton of soda ash produced, limestone calcination consumes 4.2 GJ of thermal energy and 0.1 GJ of electrical energy (Sathaye et al., “Assessment of Energy Use and Energy Savings Potential in Selected Industrial Sectors in India”, Lawrence Berkeley National Laboratory, 2005). According to the preferred embodiment of the present invention, ammonia generation is achieved by a two-stage decomposition of ammonium chloride in molten ammonium bisulfate at about 200-380° C.:

NH₄Cl(s)+NH₄HSO₄(s)−>(NH₄)₂SO₄(s)+HCl(g)−68.34 kJ (NH)₄SO₄(s)−>NH₄HSO₄(s)+NH₃(g)−108 kJ

These two endothermic reactions occur at temperatures much lower than that of limestone calcination and require similar quantity of thermal energy to proceed. Therefore, to generate the quantity of ammonia required for producing an equivalent of one metric ton of soda ash using the two-stage decomposition method would consume less than 4.2 GJ of thermal energy and 0.1 GJ of electrical energy. Based on these estimates, if the present invention was applied to sequester CO₂ and produce soda ash and hydrochloric acid, its overall energy consumption would be lower than that of the Solvay process, which produces only soda ash, and also lower than that of the Dual process, if the energy consumption of ammonia production is included. In the Dual process, ammonia is produced using the Haber-Bosch process, which also coproduces CO₂. The present invention is, energy-wise, more cost-effective than current industrial practices. If the present invention was applied solely for sequestering CO₂, the energy intensive sodium bicarbonate calcination and drying and purification processes become unnecessary and the energy consumption would be much reduced. A maximum of 7.1 GJ of total energy would be required to sequester 0.83 metric tons of CO₂ and produce 1.6 metric ton of sodium bicarbonate and 1.6 m³ of 36 wt % hydrochloric acid.

TABLE 1
Comparison of the Quantities of Raw Material, Byproduct and Waste in
the Production of One Metric Ton of Soda Ash or Equivalent using the Solvay process,
the Dual Process and the Present Invention

| | Solvay Process | Dual Process | Present Invention |
|---|---|---|---|
| Raw material | ~0.94 T (metric ton) CaCO₃ | ~0.32 T NH₃ | ~0.83 T CO₂ |
| | ~1.6 T NaCl | ~0.415 T CO₂ | ~1.1 T NaCl |
| | | ~1.1 T NaCl | |
| Product | ~1.0 T Na₂CO₃ | ~1.0 T Na₂CO₃ | ~1.6 T NaHCO₃ or |
| | | | ~1.0 T Na₂CO₃ |
| Byproduct | none | ~1.0 T NH₄Cl | ~0.69 T HCl gas or |
| | | | ~1.6 m³ of 36 wt % HCl acid |
| Waste | ~5.3 m³ liquid waste that contains | none | none |
| | ~1.05 T CaCl₂ & ~0.5 T NaCl | | |

TABLE 2
Comparison of Energy Consumptions of the Solvay Process, the Dual
Process and Present Invention (energy unit: GJ per metric ton of soda ash produced)

| | Solvay Process | | Dual Process | | Present Invention | |
|---|---|---|---|---|---|---|
| | Thermal | Electrical | Thermal | Electrical | Thermal | Electrical |
| Limestone Calcination | 4.2 | 0.1 | | | | |
| Salt Purification | 0.4 | 0.1 | 0.4 | 0.1 | 0.4 | 0.1 |
| NaHCO₃ | 4.2 | 0.1 | 4.2 | 0.1 | 4.2* | 0.1* |
| Calcination | | | | | | |
| Drying & Purification | 4.2 | 0.1 | 4.2 | 0.1 | 4.2* | 0.1* |
| Ammonia Recovery | 2.5 | 0 | | | 4.2 | 0.1 |
| NH₄Cl Precipitation | | | 0 | 0.7 | 0 | 0.7 |
| Utilities and Others | 0.4 | 0.7 | 0.4 | 1.2 | 0.4 | 1.2 |
| Total | 15.9 | 1.1 | 9.2 | 2.2 | 13.4 or 5.0 | 2.3 or 2.1 |

Data from Sathaye et al. (2005) Assessment of Energy Use and Energy Savings Potential in Selected Industrial Sectors in India. Lawrence Berkeley National Laboratory;
*Optional steps;

Although the present invention has been described in considerable detail with reference to certain preferred versions thereof, other versions are possible. Therefore, the spirit and scope of the appended claims should not be limited to the description of the preferred versions contained therein.

What is claimed is:

1. A method for sequestering at least a portion of CO₂ from a volume or stream of CO₂-bearing gas, comprising:
(a) reacting an ammonium salt with either acidic or basic materials, whereby generating ammonia;
(b) dissolving said ammonia in a recycled aqueous solution, whereby producing a basic ammoniated solution;
(c) reacting said volume or stream of CO₂-bearing gas with said basic ammoniated solution, whereby removing at least a portion of CO₂ from said CO₂-bearing gas, precipitating said CO₂ as bicarbonate, and resulting in a CO₂-depleted gas and said recycled aqueous solution; and
(d) removing said precipitated bicarbonate from said recycled aqueous solution.

2. The method of claim 1, wherein said ammonium salt is selected from the group consisting of ammonium chloride, ammonium sulfate, ammonium bisulfate, ammonium nitrate, ammonium carbonate, ammonium bicarbonate, and ammonium phosphate.

3. The method of claim 1, wherein said acidic materials are selected from the group consisting of ammonium bisulfate, sodium bisulfate, and sulfuric acid.

4. The method of claim 1, wherein said basic materials are selected from the group consisting of calcium oxide, cement kiln dust, CaO-rich fly ash, waste concrete, steel and iron slag, limestone, dolomite, and silicate rocks or mining wastes that are rich in serpentine, olivine or wollastonite.

5. The method of claim 1, wherein said reactions between said ammonium salt and said basic materials are carried out in slurry.

6. The method of claim 1, wherein said dissolution of said ammonia in said recycled aqueous solution is carried out at temperatures below about 40° C. (degrees Celsius) and under ambient pressure.

7. The method of claim 1, wherein said reactions between said CO₂-bearing gas and said basic ammoniated solution are carried out at temperatures below about 60° C. and under pressures in the range of about 100 kPa (ambient pressure) to about 400 kPa in a carbonation device that consists of either one reactor or a series of connected reactors.

8. The method of claim 1, wherein said reactions between said CO₂-bearing gas and said basic ammoniated solution are carried out at temperatures below about 40° C. and under pressures in the range of about 100 kPa (ambient pressure) to about 400 kPa in a carbonation device that consists of either one reactor or a series of connected reactors.

9. The method of claim 1, wherein said basic ammoniated solution is a basic ammoniated sodium chloride solution.

10. The method of claim 1, wherein said basic ammoniated solution is a basic ammoniated aqueous solution.

11. The method of claim 1, further comprising washing said CO₂-depleted gas with either cold water or an acidic solution or both, whereby recovering residual ammonia before releasing said CO₂-depleted gas to the atmosphere.

12. The method of claim 1, further comprising washing said CO₂-bearing gas with either cold water or a cold basic solution, whereby cooling said CO₂-bearing gas to temperatures below about 60° C. and removing solid particles and strong acidic gases from said CO₂-bearing gas prior to CO₂ sequestration.

13. A method for sequestering at least a portion of CO₂ from a volume or stream of CO₂-bearing gas and for producing sodium bicarbonate, comprising the steps of:
(a) reacting a recycled ammonium salt with either acidic or basic materials, whereby generating ammonia;
(b) dissolving said ammonia and a sodium salt in a recycled ammonium salt solution at temperatures below about 40° C., whereby precipitating said recycled ammonium salt and producing a basic ammoniated sodium salt solution;
(c) removing said recycled ammonium salt from said basic ammoniated sodium salt solution;
(d) reacting said volume or stream of CO₂-bearing gas with said basic ammoniated sodium salt solution, whereby removing at least a portion of CO₂ from said CO₂-bearing gas, precipitating said CO₂ as sodium bicarbonate, and resulting in a CO₂-depleted gas and said recycled ammonium salt solution; and
(e) removing said sodium bicarbonate from said recycled ammonium salt solution.

14. The method of claim 13, wherein said sodium salt is sodium chloride.

15. The method of claim 13, wherein said sodium salt is selected from the group consisting of sodium chloride, sodium sulfate, and sodium nitrate.

16. The method of claim 13, further comprising the steps of:
(a) calcinating said sodium bicarbonate at temperatures in the range of about 160° C. to about 230° C., whereby producing sodium carbonate and pure CO₂; and
(b) disposing said sodium carbonate to a body of seawater of the ocean, whereby mitigating acidification of said body of seawater and enhancing atmospheric CO₂ uptake by said body of seawater.

17. The method of claim 13, wherein said reactions between said CO₂-bearing gas and said basic ammoniated sodium salt solution are carried out at temperatures below about 60° C. and under pressures in the range of about 100 kPa to about 400 kPa in a carbonation device that consists of either one reactor or a series of connected reactors.

18. The method of claim 13, wherein said recycled ammonium salt is ammonium chloride.

19. The method of claim 13, wherein said recycled ammonium salt is selected from the group consisting of ammonium chloride, ammonium sulfate, and ammonium nitrate.

20. A method for generating ammonia for CO₂ sequestration, comprising reacting an ammonium salt with a basic CaO-rich waste material in slurry, wherein said ammonium salt is selected from the group consisting of ammonium chloride, ammonium sulfate, ammonium bisulfate, ammonium nitrate, ammonium carbonate, ammonium bicarbonate, and ammonium phosphate, and wherein said basic CaO-rich waste material is selected from the group consisting of cement kiln dust, CaO-rich fly ash, waste concrete, and steel and iron slag.
